(19) United States
(12) Patent Application Publication
(10) Pub. No.: US 2016/0059557 A1
(43) Pub. Date: Mar. 3, 2016

(54) ELEMENT SUBSTRATE AND LIQUID EJECTION HEAD

(71) Applicant: CANON KABUSHIKI KAISHA, Tokyo (JP)

(72) Inventors: Toshifumi Yoshioka, Hiratsuka-shi (JP); Toru Nakakubo, Kawasaki-shi (JP); Shinichiro Watanabe, Kawasaki-shi (JP)

(21) Appl. No.: 14/832,438

(22) Filed: Aug. 21, 2015

(30) Foreign Application Priority Data
Aug. 29, 2014 (JP) 2014-175520

(51) Int. Cl. B41J 2/14

(52) U.S. Cl. CPC B41J 2/14233

(57) ABSTRACT

Provided is an element substrate including an orifice for ejecting liquid, a diaphragm for causing the liquid to be ejected through the orifice, a piezoelectric element for deforming the diaphragm, a pressure chamber for applying a pressure due to deformation of the diaphragm to the liquid, and a flow reducing portion communicating with the pressure chamber and having a width that is smaller than that of the pressure chamber. A connecting portion is formed for communication between the pressure chamber and the flow reducing portion. The connecting portion and the pressure chamber communicate with each other without level difference in the width direction, and the connecting portion has a depth that is smaller than a depth of the pressure chamber.

### BACKGROUND OF THE INVENTION

1. Field of the Invention

The present invention relates to an element substrate for ejecting liquid and a liquid ejection head including the element substrate.

2. Description of the Related Art

A liquid ejection device for ejecting liquid such as ink to record an image on a recording medium generally has a liquid ejection head mounted thereon that includes an element substrate.

As a mechanism for ejecting liquid from the element substrate, one using a pressure chamber that contracts through the action of a piezoelectric element is known. In an element substrate having such a mechanism, a wall of the pressure chamber is a diaphragm. Through application of a voltage to the piezoelectric element leading to deformation of the piezoelectric element, the diaphragm warps, and the pressure chamber contracts and expands. The contraction of the pressure chamber applies a pressure to liquid in the pressure chamber, and the liquid is ejected through an orifice communicating with the pressure chamber.

A supply path is formed in the element substrate, and the liquid is supplied from the supply path to the pressure chamber. The supply path has a cross section perpendicular to a flow direction of the liquid (hereinafter referred to as “flow path cross section”) that is smaller than a flow path cross section of the pressure chamber, and functions as a flow reducing portion. It is known that usage of the supply path as a flow reducing portion maintains a certain level of a flow path resistance of liquid that flows into the pressure chamber to stabilize ejection characteristics of the element substrate.

In recent years, a liquid ejection device that can render an image at high speed is required. In order to render an image at high speed, it is necessary to shorten an ejection cycle of each pressure chamber. It is proposed that, as the ejection cycle is shortened, a volume of the liquid related to the ejection, that is, a capacity of the pressure chamber, is reduced to reduce a compliance of the liquid. The reduction in compliance increases a natural frequency of the pressure chamber, and thus, even if the ejection cycle is shortened, the liquid can be ejected with efficiency.

Further, a structure is known in which the flow path cross section of the flow reducing portion is further reduced along with downsizing of the pressure chamber (Japanese Patent Application Laid-Open No. 2012-532772). In an element substrate disclosed in Japanese Patent Application Laid-Open No. 2012-532772, a flow reducing portion and a pressure chamber are formed between a diaphragm and an orifice forming member. Reducing a distance between the diaphragm and the orifice forming member reduces the flow path cross section of the flow reducing portion and the capacity of the pressure chamber. Therefore, a frequency response of the pressure chamber can be improved without loss of stability of the ejection characteristics of the element substrate.

According to a technology disclosed in Japanese Patent Application Laid-Open No. 2012-532772, the pressure chamber and a flow inlet and a flow outlet that function as a flow reducing portion are formed by filling one of holes formed in a silicon layer on the diaphragm with the orifice forming member. The pressure chamber and the flow reducing portion have the same depth that hereinafter means a dimension in a depth direction of the hole described above (the same shall apply hereinafter). By forming a hole corresponding to the flow reducing portion so as to have a width that hereinafter means a dimension in a direction perpendicular to the flow direction of the liquid and to the depth direction (the same shall apply hereinafter), which is smaller than a width of a through hole corresponding to the pressure chamber, a flow path resistance of the flow reducing portion is secured.

The diaphragm is located at a bottom of the hole described above, and forms a wall of the pressure chamber and a wall of the flow reducing portion. When the liquid is to be ejected, a voltage is applied to a piezoelectric element formed on the diaphragm, and the piezoelectric element is deformed. The deformation of the piezoelectric element is accompanied by a warp of the diaphragm to contract and expand the pressure chamber. As a result, when the pressure chamber contracts, a pressure is applied to the liquid in the pressure chamber to eject the liquid through an orifice.

However, in the element substrate disclosed in Japanese Patent Application Laid-Open No. 2012-532772, a region of the diaphragm that warps is in a shape protruding from the pressure chamber side to the flow reducing portion side in plan view. Therefore, when a voltage is applied to the piezoelectric element, distortion stress is produced in a portion of the diaphragm in the vicinity of the protruding portion. As a result, durability of the diaphragm may be reduced and the diaphragm may be broken.

### SUMMARY OF THE INVENTION

It is an object of the present invention to provide an element substrate capable of rendering an image at high speed, which is less liable to reduce its durability and is less liable to be broken.

In order to achieve the above-mentioned object, according to an aspect of the present invention, there is provided an element substrate, including: an orifice for ejecting liquid; a diaphragm for causing the liquid to be ejected through the orifice; a piezoelectric element for deforming the diaphragm; a pressure chamber for applying a pressure due to deformation of the diaphragm to the liquid; a flow reducing portion communicating with the pressure chamber and having a width that is smaller than a width of the pressure chamber; and a connecting portion for communication between the pressure chamber and the flow reducing portion, the connecting portion and the pressure chamber communicating with each other without level difference in a width direction, the connecting portion having a depth that is smaller than a depth of the pressure chamber.

Further, according to another aspect of the present invention, there is provided an element substrate, including: an orifice for ejecting liquid; a diaphragm for causing the liquid to be ejected through the orifice; a piezoelectric element for deforming the diaphragm; a pressure chamber for applying a pressure due to deformation of the diaphragm to the liquid; a flow reducing portion communicating with the pressure chamber and having a width that is smaller than a width of the pressure chamber; and a connecting portion for communication between the pressure chamber and the flow reducing portion, the connecting portion and the pressure chamber communicating with each other without level difference in a width direction, in which, when seen from a direction perpendicular to the diaphragm, a boundary between the connecting portion and the pressure chamber extends in one of a linear shape and an arc shape.

Further, according to still another aspect of the present invention, there is provided an element substrate, including: an orifice forming member having an orifice for ejecting liquid formed therein; a diaphragm for generating a pressure for ejecting the liquid through the orifice; a flow path forming member for, together with the orifice forming member and the diaphragm, forming a pressure chamber for applying the pressure from the diaphragm to the liquid; a flow reducing portion communicating with the pressure chamber and having a flow path wall formed by the orifice forming member and the flow path forming member; and a connecting portion formed between the pressure chamber and the flow reducing portion, for communication between the pressure chamber and the flow reducing portion, the pressure chamber having a width that is larger than a width of the flow reducing portion, the connecting portion being formed by the flow path forming member and communicating with the pressure chamber without level difference in a width direction.

According to the present invention, the connecting portion and the pressure chamber communicate with each other without level difference in the width direction, and thus, a protruding portion or a corner portion can be eliminated from a region of the diaphragm that warps. Therefore, local distortion stress can be prevented from being produced in the diaphragm. As a result, the diaphragm has improved durability and is less liable to be broken.

Further features of the present invention will become apparent from the following description of exemplary embodiments with reference to the attached drawings.

### BRIEF DESCRIPTION OF THE DRAWINGS

FIGS. 1A, 1B, 1C, and 1D are sectional views and a partial enlarged perspective view of an element substrate according to a first embodiment of the present invention.

FIGS. 2A, 2B, 2C, 2D, 2E, 2F, and 2G are illustrations of a method of manufacturing the element substrate illustrated in FIGS. 1A to 1D.

FIGS. 3A and 3B are a sectional view and a plan view, respectively, of a substrate and a drive layer illustrated in FIG. 2A.

FIGS. 4A and 4B are illustrations of a first resist and a second resist in the manufacturing method illustrated in FIGS. 2A to 2G.

FIGS. 5A and 5B are illustrations of the method of manufacturing the element substrate illustrated in FIGS. 1A to 1D.

FIGS. 6A and 6B are illustrations of the method of manufacturing the element substrate illustrated in FIGS. 1A to 1D.

FIGS. 7A and 7B are illustrations of the method of manufacturing the element substrate illustrated in FIGS. 1A to 1D.

FIGS. 8A and 8B are illustrations of the method of manufacturing the element substrate illustrated in FIGS. 1A to 1D.

FIGS. 9A and 9B are illustrations of a first resist and a second resist according to a comparative example of the present invention.

FIGS. 10A and 10B are illustrations of a method of manufacturing an element substrate according to the comparative example.

FIGS. 11A and 11B are illustrations of the method of manufacturing the element substrate according to the comparative example.

FIGS. 12A and 12B are illustrations of the method of manufacturing the element substrate according to the comparative example.

FIGS. 13A and 13B are illustrations of the method of manufacturing the element substrate according to the comparative example.

FIGS. 14A and 14B are illustrations of a first resist and a second resist according to a second embodiment of the present invention.

FIGS. 15A and 15B are illustrations of a method of manufacturing an element substrate according to the second embodiment.

FIG. 16 is a sectional view of an element substrate according a third embodiment of the present invention.

FIGS. 17A, 17B, 17C, 17D, 17E, 17F, 17G, 17H, 17I, 17J, and 17K are illustrations of a method of manufacturing the element substrate illustrated in FIG. 16.

FIGS. 18A, 18B, 18C, 18D, 18E, 18F, 18G, 18H, 18I, and 18J are illustrations of the method of manufacturing the element substrate illustrated in FIG. 16.

FIGS. 19A, 19B, 19C, 19D, 19E, 19F, 19G, and 19H are illustrations of the method of manufacturing the element substrate illustrated in FIG. 16.

### DESCRIPTION OF THE EMBODIMENTS

Embodiments for carrying out the present invention are described in the following with reference to the attached drawings.

### First Embodiment

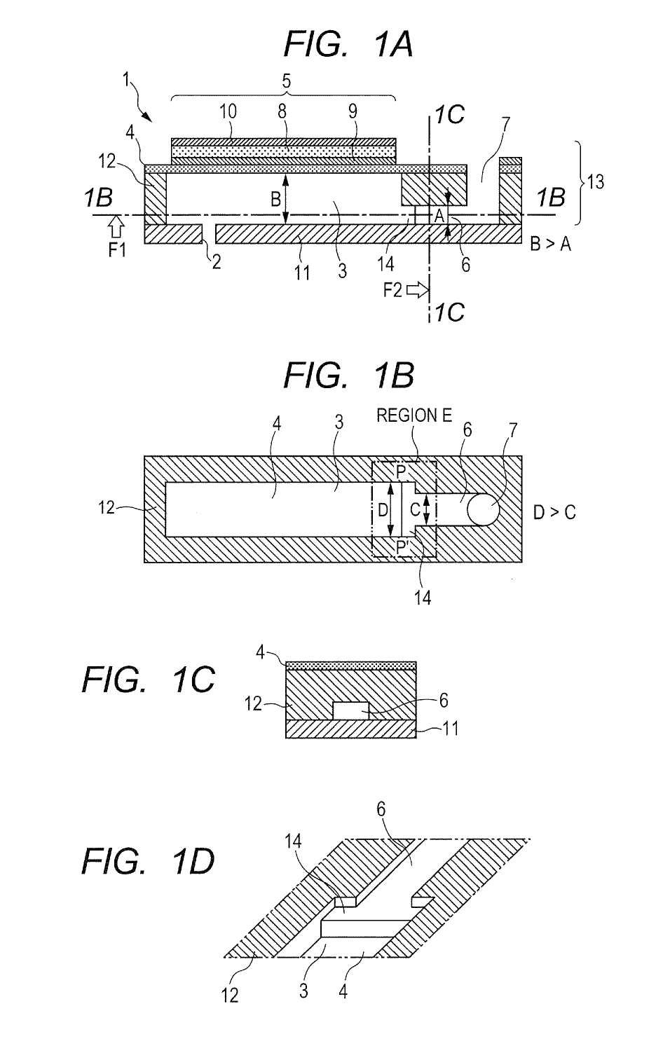

FIGS. 1A to 1D are schematic views for illustrating an element substrate according to the present invention. FIG. 1A is a side sectional view (sectional side elevation or vertical section), FIG. 1B is a sectional view taken along the line 1B-1B of FIG. 1A when seen from a direction of the arrow F1, FIG. 1C is a sectional view taken along the line 1C-1C of FIG. 1A when seen from a direction of the arrow F2, and FIG. 1D is an enlarged perspective view of a region E illustrated in FIG. 1B.

As illustrated in FIGS. 1A to 1D, an element substrate 1 includes an orifice 2 for ejecting liquid and a pressure chamber 3 for storing the liquid ejected through the orifice 2 and for applying an ejection pressure to the liquid. One of walls of the pressure chamber 3 is formed of a diaphragm 4. An actuating portion 5 is joined to the diaphragm 4. Actuation of the actuating portion 5 deforms the diaphragm 4 to apply a pressure to the liquid in the pressure chamber 3. It is preferred that the actuating portion 5 be formed on the outside of the pressure chamber 3.

The element substrate 1 further includes a flow reducing portion 6 that communicates with the pressure chamber 3 and a communicating hole 7 that extends from the flow reducing portion 6 to a common liquid chamber (not shown). The liquid is supplied from the common liquid chamber to the pressure chamber 3 via the communicating hole 7 and the flow reducing portion 6.

The flow reducing portion 6 is shallower than the pressure chamber 3 (a depth A of the flow reducing portion 6 is smaller than a depth B of the pressure chamber 3), and has a smaller width than the pressure chamber 3 (a flow path width C of the flow reducing portion 6 is smaller than a flow path width D of the pressure chamber 3). Therefore, a flow path cross section of the flow reducing portion 6 is smaller than a flow path cross section of the pressure chamber 3, and the flow reducing portion 6 functions to maintain a certain level of a flow path resistance of the liquid that flows from the flow reducing portion 6 into the pressure chamber 3. The liquid in the flow reducing portion 6 has a relatively large inertia, and thus, when a pressure is applied to the liquid in the pressure chamber 3, much of the liquid flows toward the orifice 2.

Note that, the depth B and the flow path width C of the flow reducing portion 6 are appropriately set depending on an area of the flow path cross section of the pressure chamber 3, a volume of the pressure chamber 3, characteristics of the actuating portion, specifications of the orifice 2, a viscosity of the liquid to be ejected, an ejection frequency, a processing accuracy, and the like.

The actuating portion 5 includes a piezoelectric element 8, and a first electrode 9 and a second electrode 10 opposed to each other with the piezoelectric element 8 sandwiched therebetween. The first electrode 9 is joined to the diaphragm 4. The first electrode 9 and the second electrode 10 are connected to wiring (not shown), and the wiring is led out to a control circuit outside the element substrate 1. The first electrode 9 is, for example, a common electrode, and the second electrode 10 is, for example, an individual electrode.

When the element substrate 1 is actuated, an electrical signal is transmitted from the control circuit to the first electrode 9 and the second electrode 10 via the wiring (not shown). This applies a voltage to the piezoelectric element 8 to deform the piezoelectric element 8. Based on the deformation of the piezoelectric element 8, the diaphragm 4 warps and the pressure chamber 3 contracts and expands. The contraction of the pressure chamber 3 is accompanied with pressure application to the liquid in the pressure chamber 3 to eject the liquid through the orifice 2.

The orifice 2 is a through hole formed in an orifice forming member 11. The orifice forming member 11 is formed so as to be opposed to the diaphragm 4 with space provided therebetween. A flow path forming member 12 is formed between the orifice forming member 11 and the diaphragm 4. The pressure chamber 3 is formed by the diaphragm 4, the orifice forming member 11, and the flow path forming member 12. The flow reducing portion 6 is formed by the orifice forming member 11 and the flow path forming member 12. A member including the flow path forming member 12, the diaphragm 4, the first electrode 9, the piezoelectric element 8, and the second electrode 10 is also referred to as an actuator substrate 13. It is preferred that the orifice forming member 11 and the actuator substrate 13 be stacked so that the orifice 2 and the actuating portion 5 are opposed to each other.

Note that, in an example illustrated in FIGS. 1A to 1D, the pressure chamber 3 is substantially in a rectangular shape in plan view, but the shape of the pressure chamber 3 in plan view is not limited thereto, and various shapes are possible. The pressure chamber 3 may be in a substantial parallelogram, a substantial trapezoid, a substantial ellipsoid, or a substantial oval.

A connecting portion 14 for communication between the flow reducing portion 6 and the pressure chamber 3 is formed between the flow reducing portion 6 and the pressure chamber 3. The connecting portion 14 is formed so as to have a depth that is smaller than the depth B of the pressure chamber 3 and that is substantially equal to the depth A of the flow reducing portion 6. The connecting portion 14 is formed so as to have a width that is substantially equal to the flow path width C of the flow reducing portion 6 on the flow reducing portion 6 side, and so as to have a width that is substantially equal to the width D of the pressure chamber 3 on the pressure chamber 3 side. In other words, the connecting portion 14 communicates with the pressure chamber 3 without level difference in the width direction.

According to this embodiment, flow path walls of the flow reducing portion 6 are formed of the orifice forming member 11 and the flow path forming member 12, and thus, even when the diaphragm 4 warps, the flow path walls of the flow reducing portion 6 do not warp. Therefore, the flow path resistance in the flow reducing portion 6 is less liable to vary and ejection characteristics of the element substrate 1 are stable.

Further, formation of the connecting portion 14 enables an end portion of the diaphragm 4 forming the wall of the pressure chamber 3 to be formed into a substantially linear shape as shown by the line P-P′ in FIG. 1B. Therefore, there is no protruding portion and no corner portion in a region of the diaphragm 4 that warps, and distortion stress applied on the diaphragm 4 when driven can be inhibited from being produced. As a result, the diaphragm 4 can have improved durability and the highly reliable element substrate 1 can be provided at a low cost.

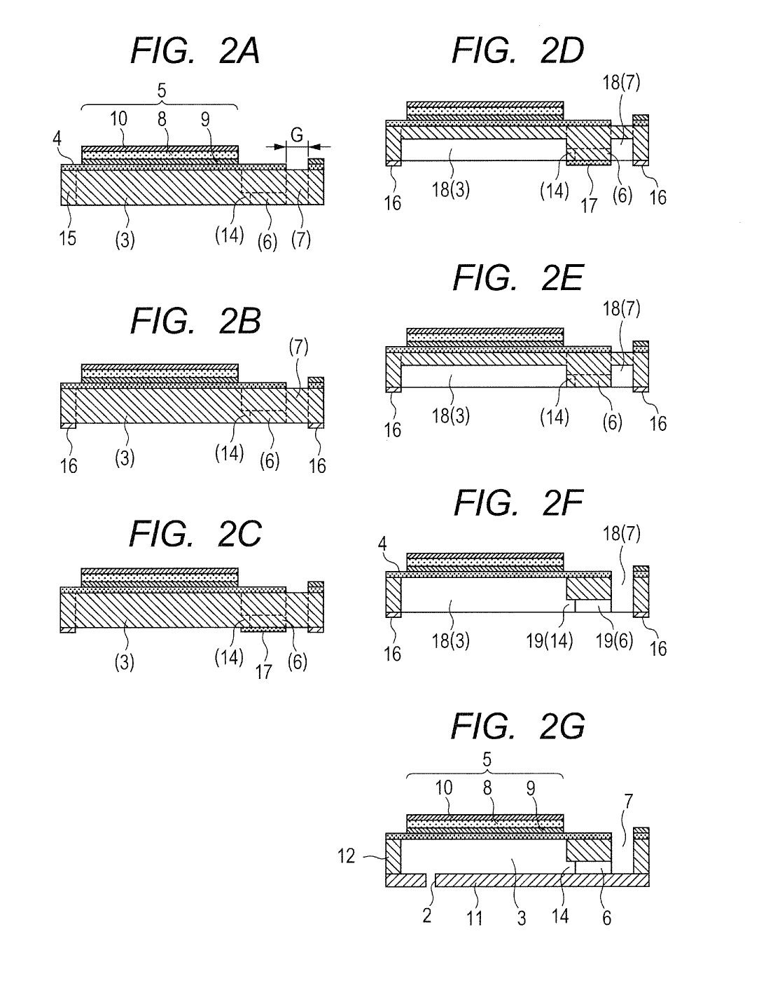

Next, a method of manufacturing the element substrate 1 is described with reference to FIGS. 2A to 2G. In FIGS. 2A to 2G, for the sake of easy understanding, regions serving as the pressure chamber 3, the flow reducing portion 6, the communicating hole 7, and the connecting portion 14 are shown by the broken lines.

First, as illustrated in FIG. 2A, the diaphragm 4, the first electrode 9, the piezoelectric element 8, and the second electrode 10 that serve as a drive layer are formed on one surface of a substrate 15 that is a silicon single crystal substrate. The first substrate 15 is a member serving as the flow path forming member 12 (see FIGS. 1A to 1D). Here, it is preferred that the diaphragm 4 and the first electrode 9 be open in a region G opposed to the communicating hole 7 to be formed in a subsequent step.

Then, as illustrated in FIG. 2B, a first resist 16 is formed on the substrate 15 using photolithography. At this time, the first resist 16 is formed so that a portion of the substrate 15 that corresponds to the pressure chamber 3, the flow reducing portion 6, and the communicating hole 7 is exposed.

The first resist 16 is only required to function as a mask when the first substrate 15 is etched. As the first resist 16, an ordinary photoresist or a photosensitive dry film, or a metal film of Cr, Al, or the like, or an inorganic oxide film or a nitride film of SiO₂, SiN, TaN, or the like can be used. In this embodiment, taking into consideration a second resist 17 (see FIG. 2C) to be formed later, SiO₂ is used as the first resist 16.

Then, as illustrated in FIG. 2C, a second resist 17 is formed using the photolithography. At this time, the second resist 17 is formed so that a portion of the substrate 15 that corresponds to the pressure chamber 3 and the communicating hole 7 is exposed. In other words, the second resist 17 covers a portion of the substrate 15 that corresponds to the flow reducing portion 6.

As the second resist 17, similarity to the first resist 16, an ordinary photoresist or a photosensitive dry film, or a metal film of Cr, Al, or the like, or an inorganic oxide film or a nitride film of SiO₂, SiN, TaN, or the like can be used. In this embodiment, taking into consideration the formed first resist 16, a positive photoresist is used as the second resist 17.

Then, as illustrated in FIG. 2D, the substrate 15 is etched with the first resist 16 and the second resist 17 being used as a mask to form a first recess 18 (first etching process). The first recess 18 is formed to midway through the substrate 15 so as not to pierce the substrate 15. The formation of the recess in the substrate 15 is also referred to as deep-RIE.

Then, as illustrated in FIG. 2E, the second resist 17 is removed with a remover or the like to expose a portion of the substrate 15 that is different from the first recess 18.

Then, as illustrated in FIG. 2F, the substrate 15 is etched with the remaining first resist 16 being used as a mask to deepen the first recess 18 and to form a second recess 19 in the substrate 15 (second etching process). The first recess 18 reaches the diaphragm 4. In this way, the flow path forming member 12 (see FIGS. 1A to 1D) formed of the substrate 15 is completed.

In this embodiment, dry etching of the substrate 15 is carried out in the first and second etching processes. The dry etching is processing in which, using a plasma reactive ion etching apparatus, etching of Si with a SF₆ gas and formation of side wall protection with a C₄F₈ gas are repeatedly carried out. Through the dry etching, the first recess 18 and the second recess 19 can be formed with higher accuracy.

Then, as illustrated in FIG. 2G, after removing the first resist 16, the orifice forming member 11 having the orifice 2 formed therein is mounted on the substrate 15 (flow path forming member 12) so as to cover an opening of the first recess 18 and an opening of the second recess 19. The pressure chamber 3 and the communicating hole 7 are formed by the first recess 18 and the orifice forming member 11, and the flow reducing portion 6 and the connecting portion 14 are formed by the second recess 19 and the orifice forming member 11. It is preferred that the orifice forming member 11 be formed so that the orifice 2 and the actuating portion 5 are opposed to each other.

Note that, in this embodiment, the orifice forming member 11 is mounted on the flow path forming member 12 after removing the first resist 16, but the first resist 16 may not be removed.

In the manufacturing method described with reference to FIGS. 2A to 2G, the substrate 15 is etched with the first resist 16 and the second resist 17 being used as the mask, and, after the second resist 17 is removed, the substrate 15 is further etched with the first resist 16 being used as the mask. This can cause the depth A of the flow reducing portion 6 to be smaller than the depth B of the pressure chamber 3 (see FIG. 1A), and thus, the flow path width C of the flow reducing portion 6 can be larger (see FIG. 1B).

Further, the connecting portion 14 is formed simultaneously with the formation of the flow reducing portion 6, and thus, the connecting portion 14 can have a depth that is substantially equal to the depth of the flow reducing portion 6.

When the first recess 18 and the second recess 19 are formed in the substrate 15, the substrate 15 may be wet etched (anisotropic etching), but it is more preferred that the substrate 15 be dry etched. By using deep-RIE of dry etching, side walls of the first recess 18 and the second recess 19 can be formed so as to be approximately perpendicular to the diaphragm 4. This can prevent the side walls of the recesses from being slanted with respect to the diaphragm 4, which occurs in the case of wet etching, and the orifice 2 can be formed with a greater area efficiency.

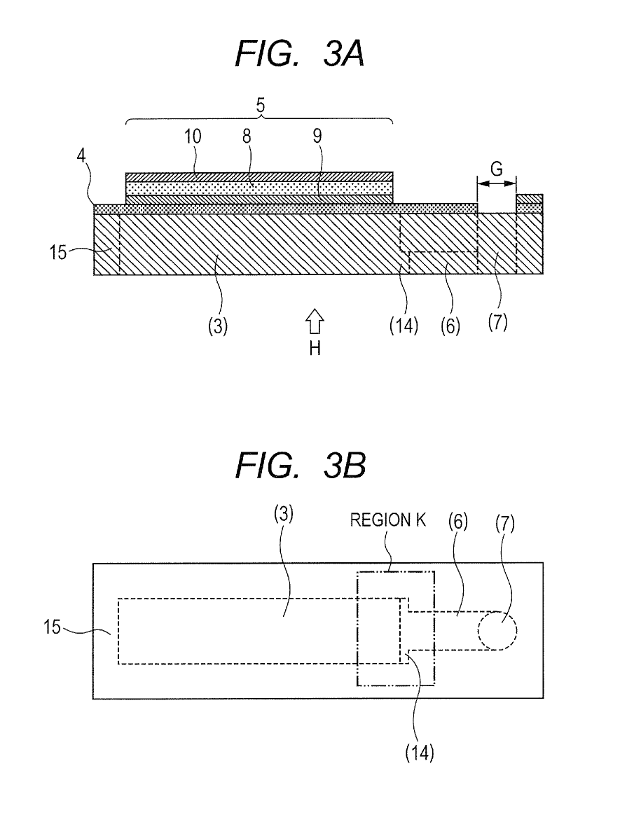

Next, the method of manufacturing the element substrate 1 is described in more detail while focusing on the width direction of the connecting portion 14, with reference to FIG. 3A to FIG. 8B. FIGS. 3A and 3B are schematic views of the substrate 15 and the drive layer to be used in the method of manufacturing the element substrate 1. FIG. 3A is a sectional view of the substrate 15, and FIG. 3B is a plan view of the substrate 15 when seen from a direction of the arrow H in FIG. 3A. Note that, in FIGS. 3A and 3B, for the sake of easy understanding, the region serving as the pressure chamber 3, the flow reducing portion 6, the communicating hole 7, and the connecting portion 14 of the element substrate 1 is shown by the broken lines.

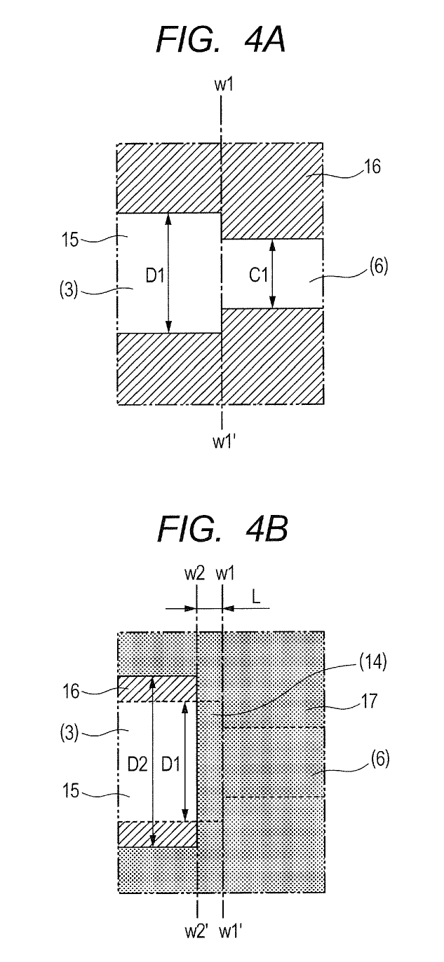

As illustrated in FIG. 3A, the diaphragm 4, the first electrode 9, the piezoelectric element 8, and the second electrode 10 that serve as the drive layer are formed on the one surface of the substrate 15 that is a silicon single crystal substrate. The diaphragm 4 and the first electrode 9 are open in the region G to be opposed to the communicating hole 7 in a subsequent step. FIGS. 4A and 4B are illustrations of the first resist 16 and the second resist 16 formed in the substrate 15, and are plan views of the region K corresponding to the vicinity of the connecting portion 14 when seen from the direction of the arrow H in FIG. 3A. Note that, the first resist 16 and the second resist 17 are hatched. In FIG. 4A, the first resist 16 is illustrated. In FIG. 4B, the first resist 16 and the second resist 17 are illustrated. With reference to FIG. 4B, part of the first resist 16 is covered with the second resist 17. In FIG. 4B, for the sake of easy understanding of a positional relationship between the first resist 16 and the second resist 17, edges of the first resist 16 are shown by the broken lines.

As illustrated in FIG. 4A, the first resist 16 has an opening formed therein, and a width of the opening changes at an exposed width change portion w1-w1′. More specifically, the opening is divided by the exposed width change portion w1-w1′ into a first opening portion and a second opening portion. The first opening portion has a width D1 and the second opening portion has a width C1 that is smaller than the width D1.

As illustrated in FIG. 4B, the second resist 17 has an opening formed therein, and a portion of the substrate 15 that corresponds to the pressure chamber 3 is exposed from the opening. The second resist 17 covers the exposed width change portion w1-w1′, and an opening edge w2-w2′ of the second resist 17 is at a distance L from the exposed width change portion w1-w1′.

Note that, in order to form the pressure chamber 3 so as to have the flow path width D1 with accuracy, a width D2 of the opening in the second resist 17 is set to be larger than the width D1 of the opening in the first resist 16.

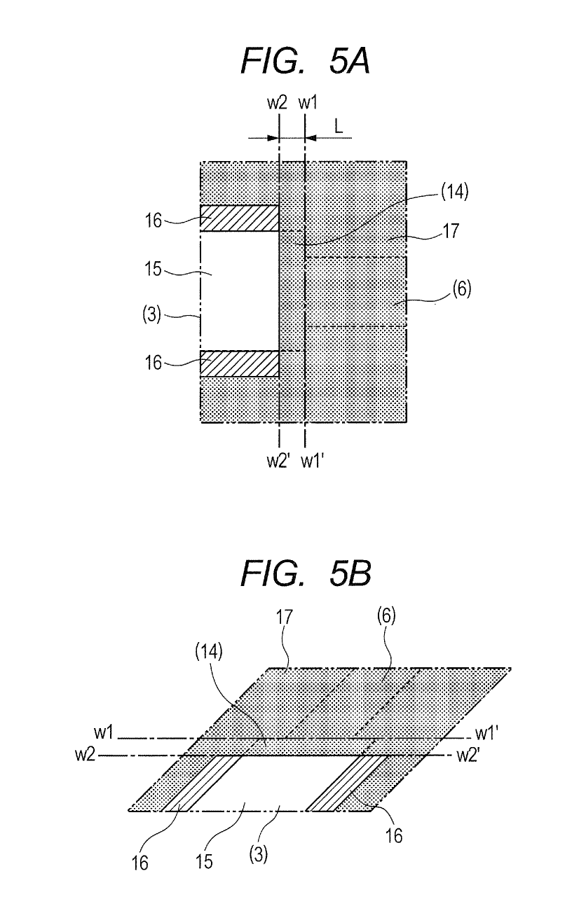

FIGS. 5A, 6A, 7A, and 8A are plan views and FIGS. 5B, 6B, 7B, and 8B are perspective views for illustrating the method of manufacturing the element substrate 1, in particular, for illustrating steps subsequent to the steps of forming the first resist 16 and the second resist 17. Note that, in FIG. 5A to FIG. 8B, only the region K (see FIG. 3B) is illustrated.

As illustrated in FIGS. 5A and 5B, the first resist 16 and the second resist 17 are formed on the surface of the substrate 15 on the side opposite to the drive layer, using the photolithography. As described above, the second resist 17 covers the exposed width change portion w1-w1′, and the opening edge w2-w2′ of the second resist 17 is at the distance L from the exposed width change portion w1-w1′.

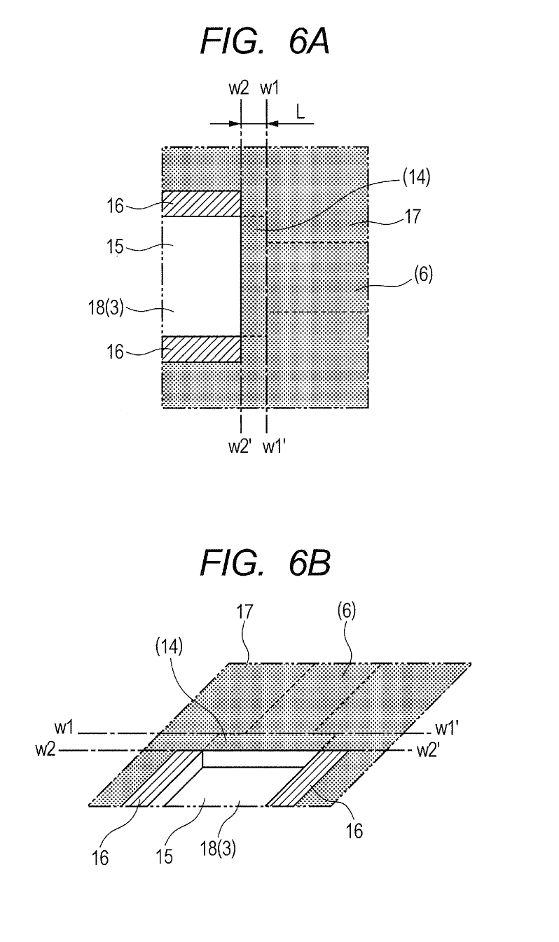

First, as illustrated in FIGS. 6A and 6B, the substrate 15 is dry etched with the first resist 16 and the second resist 17 being used as the mask to form the first recess 18 (first etching process). The formation of the recess in the substrate 15 is also referred to as deep-RIE. The first recess 18 is formed to midway through the substrate 15 so as not to pierce the substrate 15. In this case, the etching progresses along the opening edge w2-w2′ of the second resist 17, and a wall of the first recess 18 on the flow reducing portion 6 side is formed along the opening edge w2-w2′.

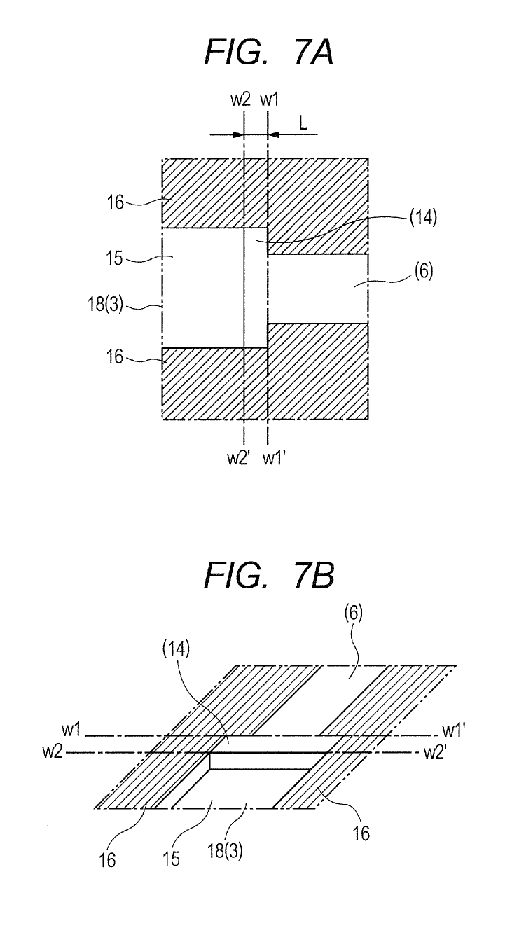

Then, as illustrated in FIGS. 7A and 7B, the second resist 17 is removed with a remover or the like to expose a portion of the substrate 15 that is different from the first recess 18.

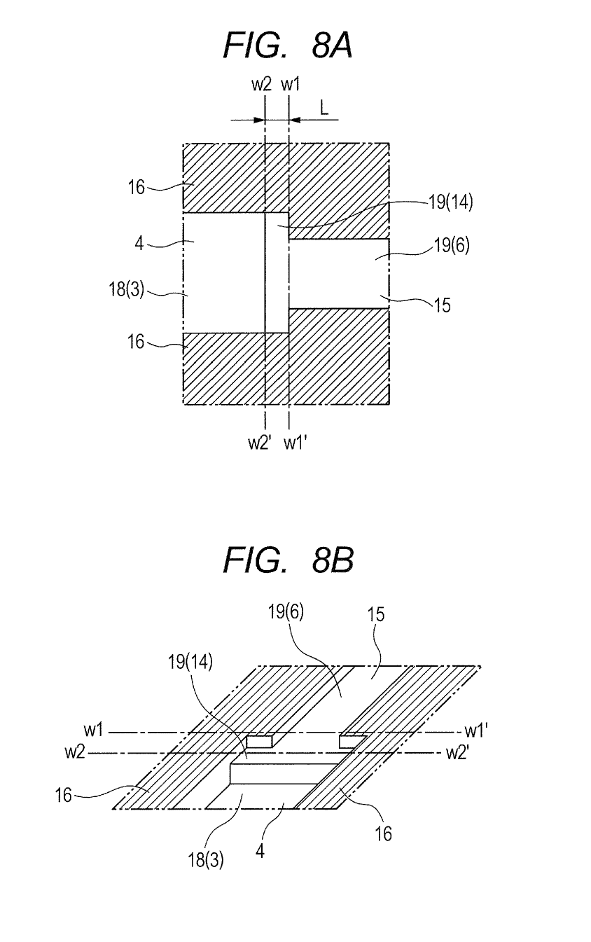

Then, as illustrated in FIGS. 8A and 8B, the substrate 15 is dry etched with the remaining first resist 16 being used as a mask to deepen the first recess 18 and to form the second recess 19 in the substrate 15 (second etching process). In the portion of the substrate 15 corresponding to the pressure chamber 3, the etching progresses along the opening in the first resist 16, and the first recess 18 becomes deeper with the width D1 being maintained.

In the portion of the substrate 15 corresponding to the flow reducing portion 6 and the connecting portion 14, the etching progresses along the opening in the first resist 16, and the second recess 19 includes a portion having the width C1 and a portion having the width D1. The connecting portion 14 is formed so as to have a width that is equal to the width of the flow reducing portion 6 on the flow reducing portion 6 side and so as to have a width that is equal to the width of the pressure chamber 3 on the pressure chamber 3 side. Further, the connecting portion 14 is formed so as to have a depth that is equal to the depth of the flow reducing portion 6. The first recess 18 reaches the diaphragm 4. In this way, the flow path forming member 12 (see FIGS. 1A to 1D) formed of the substrate 15 is completed.

Finally, the orifice forming member 11 having the orifice 2 formed therein (see FIGS. 1A to 1D) is mounted on the substrate 15 (flow path forming member 12) so as to cover the opening of the first recess 18 and the opening of the second recess 19. The pressure chamber 3 is formed by the first recess 18 and the orifice forming member 11, and the flow reducing portion 6 and the connecting portion 14 are formed by the second recess 19 and the orifice forming member 11. It is preferred that the orifice forming member be formed so that the orifice 2 and the actuating portion 5 are opposed to each other.

According to this embodiment, a boundary between the connecting portion 14 and the pressure chamber 3 is formed substantially linearly by the opening edge w2-w2′ of the second resist 17.

Thus, a vibrating end of the diaphragm 4 is formed substantially linearly. Therefore, stress applied to the end of the diaphragm 4 due to vibrations of the diaphragm 4 when driven can be uniformized, and a crack in the diaphragm 4 due to the stress can be prevented. Therefore, the diaphragm 4 has improved durability, and even in a case of an element substrate for carrying out high frequency ejection, stable ejection and a longer life can be achieved.

Note that, the distance L between the exposed width change portion w1-w1′ of the first resist 16 and the opening edge w2-w2′ of the second resist 17 can be appropriately set taking into consideration alignment accuracy and etching accuracy when the first resist 16 and the second resist 17 are formed and the like.

### Comparative Example

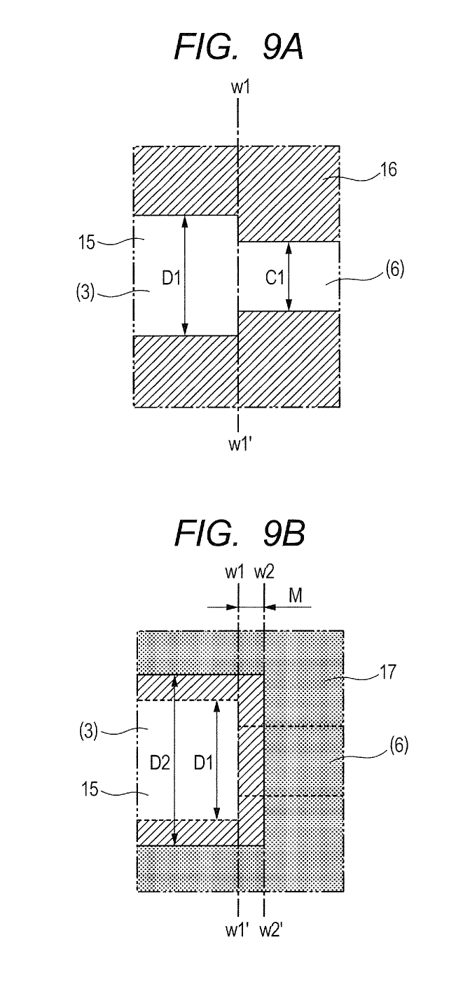

Now, a comparative example of the first embodiment is described with reference to FIG. 9A to FIG. 13B. FIGS. 9A and 9B are illustrations of the first resist 16 and the second resist 17 to be formed in the method of manufacturing the element substrate according to the comparative example, and are plan views of a portion corresponding to the region K (see FIG. 3B) when seen from the direction of the arrow H in FIG. 3A.

Note that, the first resist 16 and the second resist 17 are hatched. Similarly to the enlarged views of FIGS. 4A and 4B, in FIG. 9A, the first resist 16 is illustrated, and, in FIG. 9B, the first resist 16 and the second resist 17 are illustrated. With reference to FIG. 9B, part of the first resist 16 is covered with the second resist 17. In FIG. 9B, for the sake of easy understanding of a positional relationship between the first resist 16 and the second resist 17, edges of the first resist 16 are shown by the broken lines.

As illustrated in FIGS. 9A and 9B, in the comparative example, contrary to the case of the first embodiment, the second resist 17 does not cover the exposed width change portion w1-w1′. The opening edge w2-w2′ of the second resist 17 is at a distance M from the exposed width change portion w1-w1′ of the first resist 16. Therefore, the pressure chamber 3 includes a portion having the width D1 and a portion having the width C1.

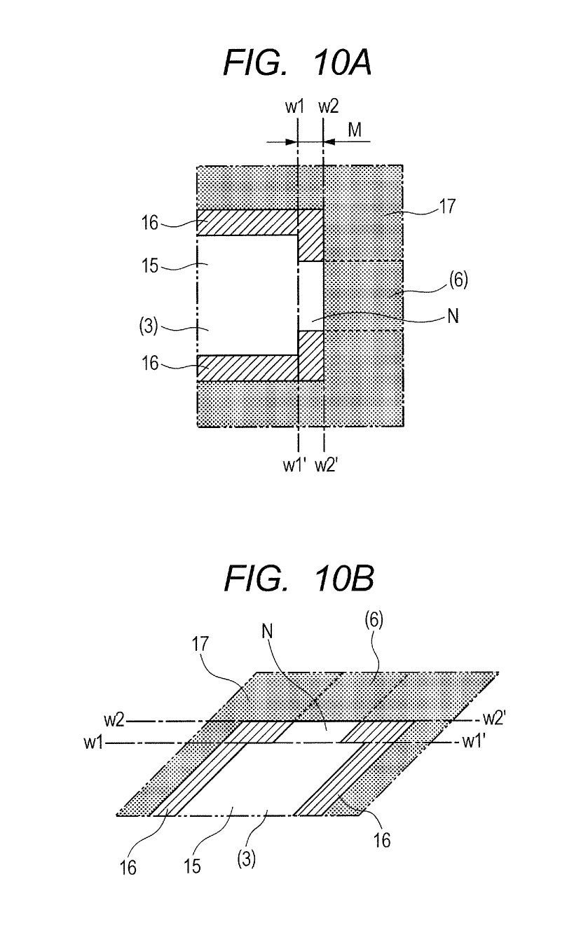

FIGS. 10A, 11A, 12A, and 13A are plan views and FIGS. 10B, 11B, 12B, and 13B are perspective views for illustrating a method of manufacturing an element substrate according to the comparative example, in particular, for illustrating steps subsequent to the steps of forming the first resist 16 and the second resist 17. Note that, in FIG. 10A to FIG. 13B, only the portion corresponding to the region K (see FIG. 3B) is illustrated.

As illustrated in FIGS. 10A and 10B, the first resist 16 and the second resist 17 are formed on the surface of the substrate 15 on the side opposite to the drive layer, using the photolithography. As described above, the second resist 17 does not cover the exposed width change portion w1-w1′, and the opening edge w2-w2′ of the second resist 17 is at the distance M from the exposed width change portion w1-w1′ of the first resist 16.

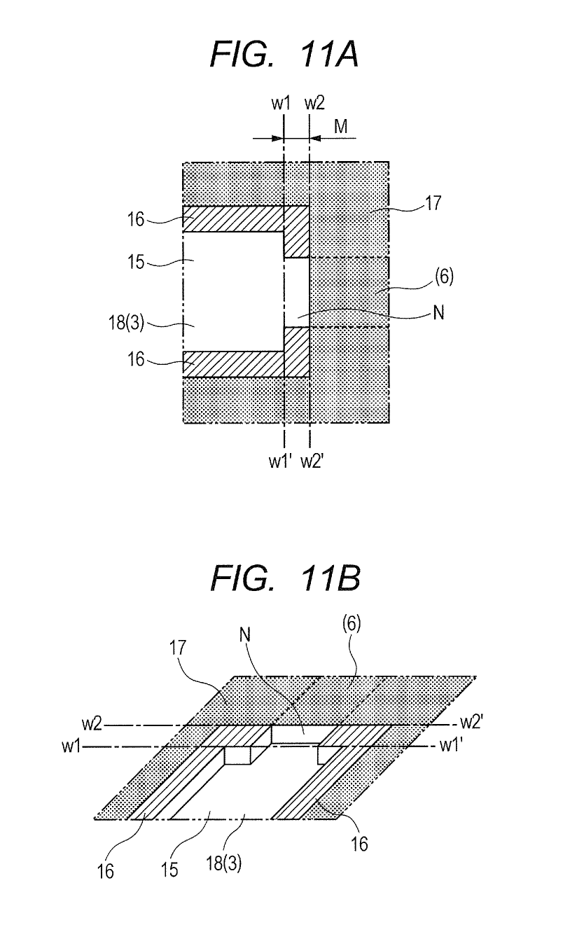

First, as illustrated in FIGS. 11A and 11B, the substrate 15 is dry etched with the first resist 16 and the second resist 17 being used as the mask to form the first recess 18 in the substrate 15 (first etching process). The first recess 18 does not pierce the substrate 15 and is formed to midway through the substrate 15.

In this case, the etching progresses along the opening edge w2-w2′ of the second resist 17, and a wall of the first recess 18 on the flow reducing portion 6 side is formed along the opening edge w2-w2′. Therefore, the first recess 18 includes a portion having the width D1 and a portion N having the width C1.

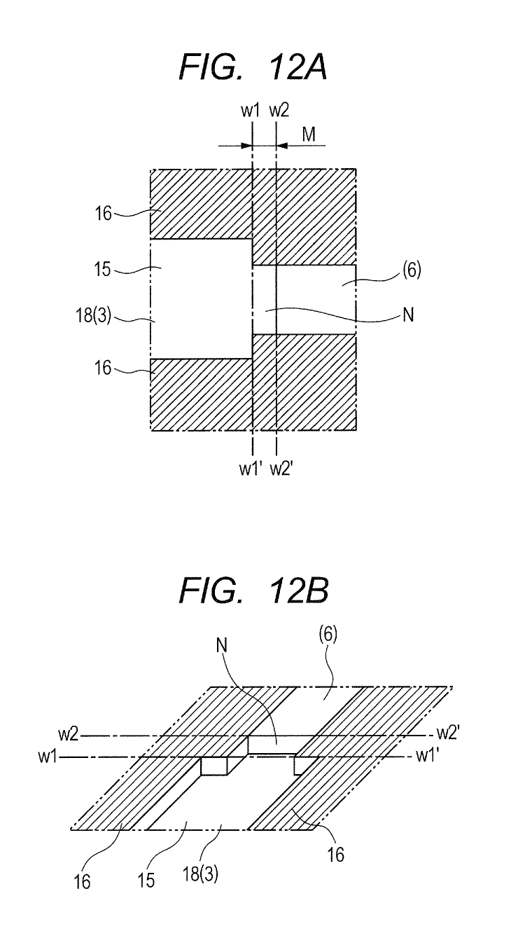

Then, as illustrated in FIGS. 12A and 12B, the second resist 17 is removed with a remover or the like to expose a portion of the substrate 15 that is different from the first recess 18.

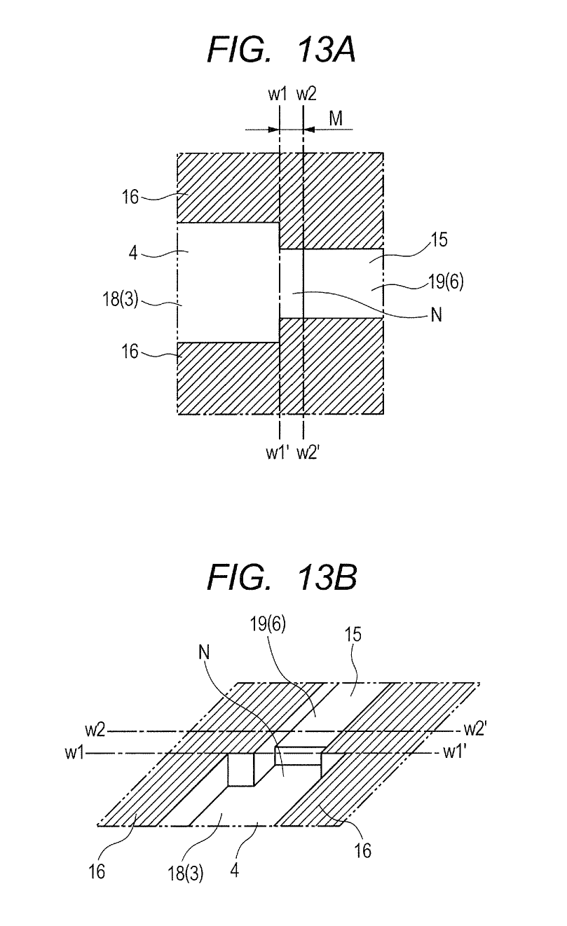

Then, as illustrated in FIGS. 13A and 13B, the substrate 15 is etched with the remaining first resist 16 being used as a mask to deepen the first recess 18 and to form the second recess 19 (second etching process). In the portion of the substrate 15 corresponding to the pressure chamber 3, the etching progresses along the opening in the first resist 16. Therefore, the first recess 18 is in a shape including the portion having the width D1 and the portion N having the width C1. In the portion of the substrate 15 corresponding to the flow reducing portion 6, the etching progresses along the opening in the first resist 16, and the second recess 19 is in a shape having the width C1. The first recess 18 reaches the diaphragm 4. In this way, the flow path forming member 12 (see FIGS. 1A to 1D) formed of the substrate 15 is completed.

Finally, the orifice forming member 11 having the orifice 2 formed therein (see FIG. 1A) is mounted on the substrate 15 (flow path forming member 12) so as to cover the opening of the first recess 18 and the opening of the second recess 19. The pressure chamber 3 is formed by the first recess 18 and the orifice forming member 11, and the flow reducing portion 6 is formed by the second recess 19 and the orifice forming member 11.

In the comparative example, the pressure chamber includes the portion N having the width C1, and the vibrating end of the diaphragm 4 is in a shape having a protruding portion with a corner portion. When the diaphragm 4 has such a protruding portion, due to the protruding portion distorted by vibrations of the diaphragm 4, a crack may develop in the diaphragm 4 by a stress. In particular, in an element substrate for carrying out high frequency ejection with high ejecting power, a crack is more liable to develop in the protruding portion of the diaphragm 4, which may reduce durability thereof.

### Second Embodiment

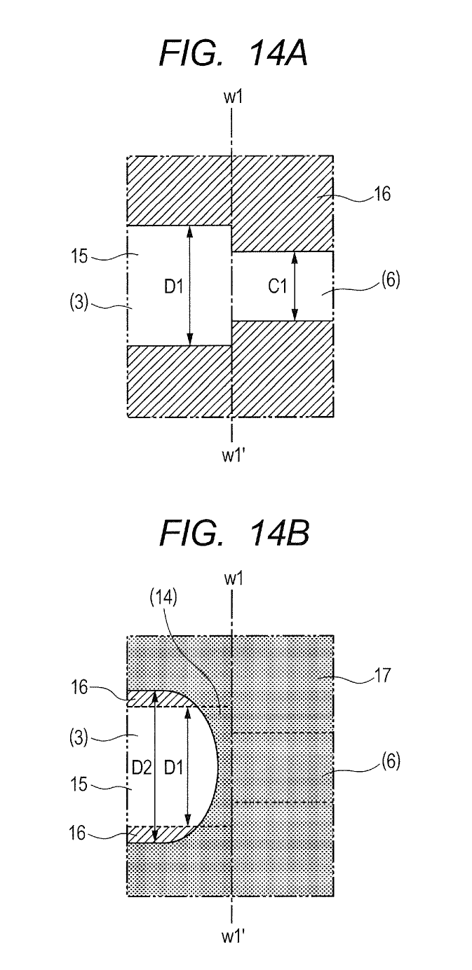

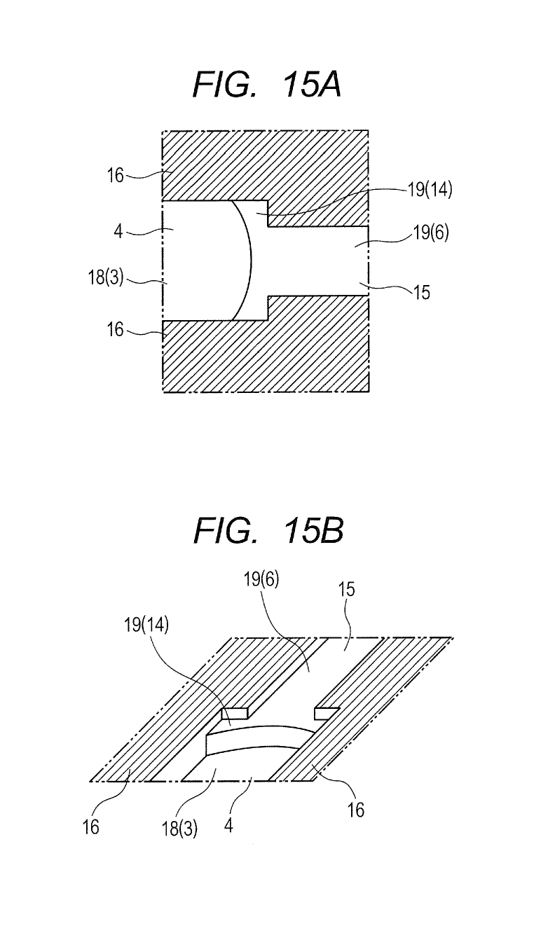

Next, a second embodiment according to the present invention is described with reference to FIGS. 14A and 14B and FIGS. 15A and 15B. FIGS. 14A and 14B are illustrations of the first resist 16 and the second resist 17 formed on the substrate 15 in manufacturing the element substrate according to this embodiment, and are plan views for illustrating a portion corresponding to the region K (see FIG. 3B) when seen from a direction of the arrow H in FIG. 3A.

Note that, the first resist 16 and the second resist 17 are hatched. In FIG. 14A, the first resist 16 is illustrated. In FIG. 14B, the first resist 16 and the second resist 17 are illustrated. With reference to FIG. 14B, part of the first resist 16 is covered with the second resist 17. In FIG. 14B, for the sake of easy understanding of a positional relationship between the first resist 16 and the second resist 17, edges of the first resist 16 are shown by the broken lines.

In the second embodiment, as illustrated in FIG. 14B, the edge of the opening in the second resist 17 is formed into an arc shape. With the use of a method similar to that in the first embodiment, the first etching process and the second etching process are carried out with the first resist 16 and the second resist 17 illustrated in FIG. 14B being used as a mask.

FIGS. 15A and 15B are a plan view and a perspective view, respectively, of the region K (see FIG. 3B) in the substrate 15 after the first etching process and the second etching process. As illustrated in FIGS. 15A and 15B, the opening edge of the second resist 17 (see FIG. 14B) is formed into the arc shape, and thus, the vibrating end of the diaphragm 4 can be formed into the arc shape. Therefore, stress applied to the end portion of the diaphragm 4 due to vibrations of the diaphragm 4 when driven can be more uniformized, and a crack in the diaphragm 4 due to the stress can be prevented. Therefore, the diaphragm 4 can have improved durability. Further, even in the case of the element substrate for carrying out high frequency ejection, stable ejection and a further longer life can be achieved.

Note that, in this embodiment, the edge of the diaphragm 4 is formed into the arc shape, but forming a portion of the diaphragm 4 adjacent to the connecting portion into the shape of a trapezoid is also effective in alleviating the stress. Further, the connecting portion 14 in this embodiment is evenly formed so as to have the same depth as that of the flow reducing portion 6 from the flow reducing portion 6 side to the pressure chamber 3 side, but it is only necessary that the depth of the connecting portion 14 on the pressure chamber 3 side be smaller than the depth of the pressure chamber 3, thereby defining the shape of the vibrating end of the diaphragm 4 so that stress applied thereto becomes smaller. For example, the connecting portion may be tapered so that the depth thereof becomes gradually larger from the flow reducing portion 6 side.

### Third Embodiment

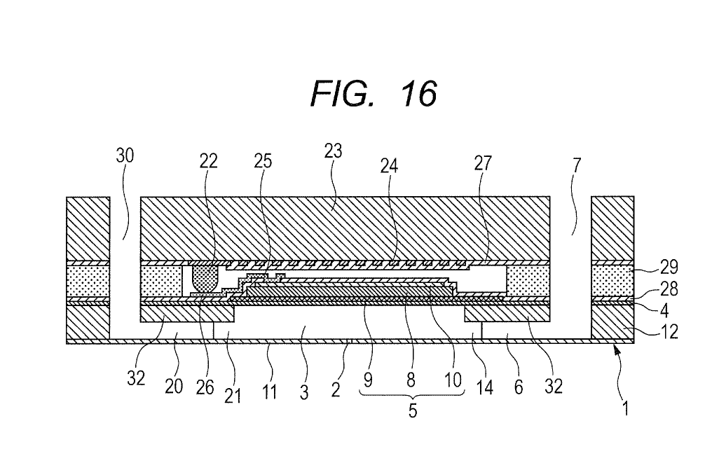

Next, a third embodiment of the present invention is described with reference to FIG. 16 to FIG. 19H. FIG. 16 is a sectional view of a liquid ejection head including the element substrate 1 according to this embodiment.

As illustrated in FIG. 16, the element substrate 1 includes the pressure chambers 3, the orifices 2 formed correspondingly to the respective pressure chambers 3, the diaphragms 4 that form walls of the pressure chambers 3, and a plurality of flow reducing portions 6 and 20 formed for each of the pressure chambers 3. The connecting portion 14 is formed between the pressure chamber 3 and the flow reducing portion 6, and a connecting portion 21 is formed between the pressure chamber 3 and the flow reducing portion 20. The actuating portion 5 is joined to the diaphragm 4. Actuation of the actuating portion 5 deforms the diaphragm 4 to apply a pressure to the liquid in the pressure chamber 3. The liquid is supplied from the flow reducing portion 6 to the pressure chamber 3, and is recovered from the pressure chamber 3 via the flow reducing portion 20. Note that, the flow reducing portion 6 is also referred to as a flow reducing portion for supplying the liquid, and the flow reducing portion 20 is also referred to as a flow reducing portion for recovering the liquid.

The actuating portion 5 includes the piezoelectric element 8, and the first electrode 9 and the second electrode 10 opposed to each other with the piezoelectric element 8 sandwiched therebetween. The first electrode 9 is joined to the diaphragm 4. The first electrode 9 and the second electrode 10 are electrically connected to wiring 24 of a wiring substrate 23 via a bump 22, and are led out to a control circuit outside the element substrate 1 via the wiring 24.

More specifically, the second electrode 10 is electrically led out via lead out wiring 25 to be connected to the bump 22 via a bump pad 26. The first electrode 9 extends under the piezoelectric element 8 that corresponds to each of the pressure chambers 3, and the first electrodes 9 are collectively connected through the bump 22 at an end portion of the element substrate 1. As the bump 22, for example, a Au bump can be used. The wiring 24 may be protected by a protective film 27. The actuating portion 5 may be protected by a protective film 28. A structure 29 may be arranged between the element substrate 1 and the wiring substrate 23.

When an electrical signal from the control circuit is applied to the piezoelectric element 8 through the wiring substrate 23, the diaphragm 4 is deformed, and the pressure chamber 3 contracts and expands. The contraction of the pressure chamber 3 applies a pressure to the liquid in the pressure chamber 3, and the liquid can be ejected through the orifice 2 due to the pressure. The flow reducing portion 6 and the flow reducing portion 20 have larger inertia than that of the orifice 2 so that the pressure generated in the pressure chamber 3 is applied to the orifice 2.

The wiring substrate 23 is joined to a plurality of element substrates 1 that are two-dimensionally arranged, and also has the function of maintaining solidity of the plurality of element substrates 1. Further, the wiring substrate 23 has, formed therein, the communicating hole 7 on the supply side that communicates with the flow reducing portion 6 and a communicating hole 30 on the recovery side that communicates with the flow reducing portion 20. The liquid is supplied from the flow reducing portion 6, and is recovered from the flow reducing portion 20 via the pressure chamber 3. In this way, the element substrate 1 forms part of a circulation path. In other words, the wiring substrate 23 has the function of supplying and recovering the liquid to and from a liquid ejecting portion, the function of arranging and supporting the liquid ejecting portion, and the function of applying an electrical control signal to the liquid ejecting portion.

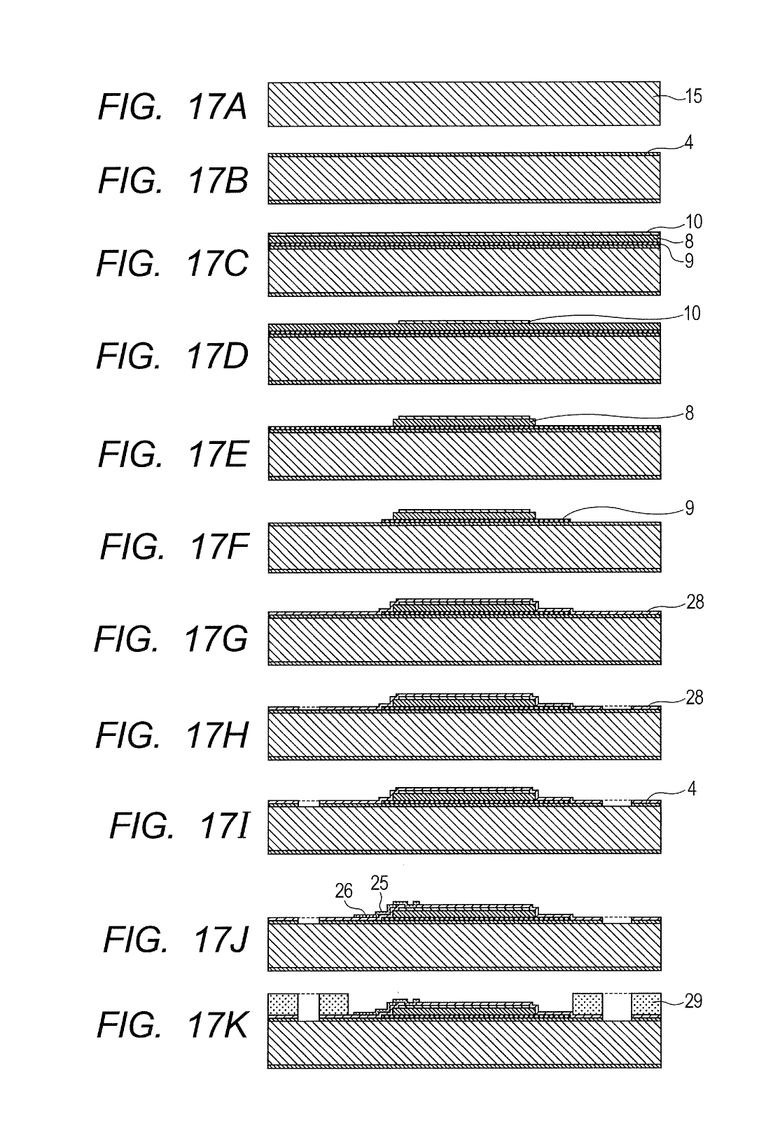

A method of manufacturing the element substrate 1 illustrated in FIG. 16 is described with reference to FIG. 17A to FIG. 19H. FIGS. 17A to 17K are illustrations of a method of forming the diaphragm 4, the actuating portion 5, the protective film 28, and the structure 29.

First, the substrate 15 formed of silicon is prepared (FIG. 17A). A silicon oxide film serving as the diaphragm 4 is formed on the substrate 15 (FIG. 17B), and the first electrode 9, the piezoelectric element 8, and the second electrode 10 are formed (FIG. 17C). Then, through etching, the second electrode 10 is patterned (FIG. 17D), the piezoelectric element 8 is patterned (FIG. 17E), and the first electrode 9 is patterned (FIG. 17F), and the protective film 28 is formed (FIG. 17G).

After that, the protective film 28 is patterned (FIG. 17H), and the silicon nitride film forming the diaphragm 4 is patterned (FIG. 17I). The lead out wiring and the bump pad 26 are formed (FIG. 17J), and a photosensitive resin is patterned to form the structure 29 (FIG. 17K).

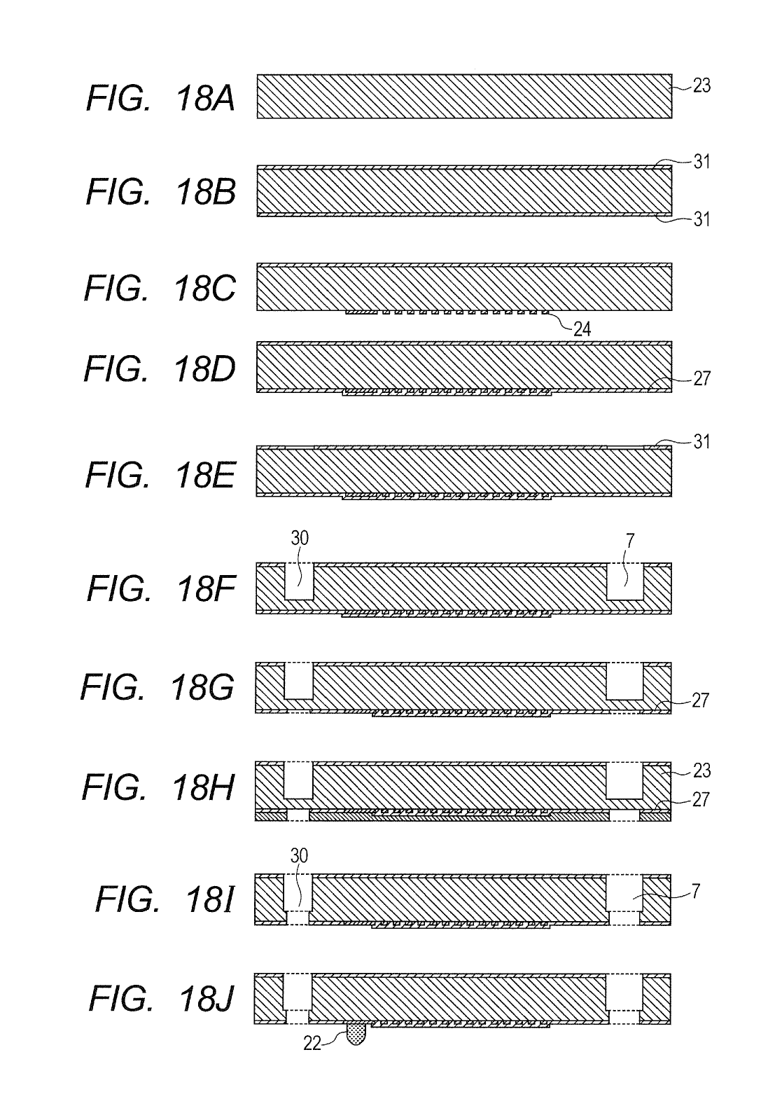

FIGS. 18A to 18J are illustrations of a method of forming the wiring 24, the protective film 28, the communicating holes 7 and 30, and the bump 22 on the wiring substrate 23. First, the wiring substrate 23 formed of silicon is prepared (FIG. 18A). A silicon oxide film 31 is formed on the wiring substrate 23 (FIG. 18B), the wiring 24 is patterned (FIG. 18C), and the protective film 27 is formed (FIG. 18D).

The communicating hole 7 on the supply side and the communicating hole 30 on the recovery side are etched by deep-RIE to midway through the wiring substrate 23 (FIG. 18F), and the protective film 27 is patterned (FIG. 18G). The wiring substrate 23 is etched from the side on which the protective film 27 is formed (FIG. 18H) so that the communicating hole 7 becomes a through hole and so that the communicating hole 30 becomes a through hole (FIG. 18I). After that, the bump 22 is formed (FIG. 18J).

The silicon oxide film 31 on the surface of the wiring substrate 23 on the side opposite to the surface on which the wiring 24 is formed is patterned (FIG. 18E). The communicating hole 7 on the supply side and the communicating hole 30 on the recovery side are etched by deep-RIE to midway through the wiring substrate 23 with the silicon oxide film 31 being used as a mask (FIG. 18F), and the protective film 27 is patterned (FIG. 18G). The wiring substrate 23 is etched from the side on which the protective film 27 is formed (FIG. 18H) to cause the communicating hole 7 to be a through hole and to cause the communicating hole 30 to be a through hole (FIG. 18I). After that, the bump 22 is formed (FIG. 18J).

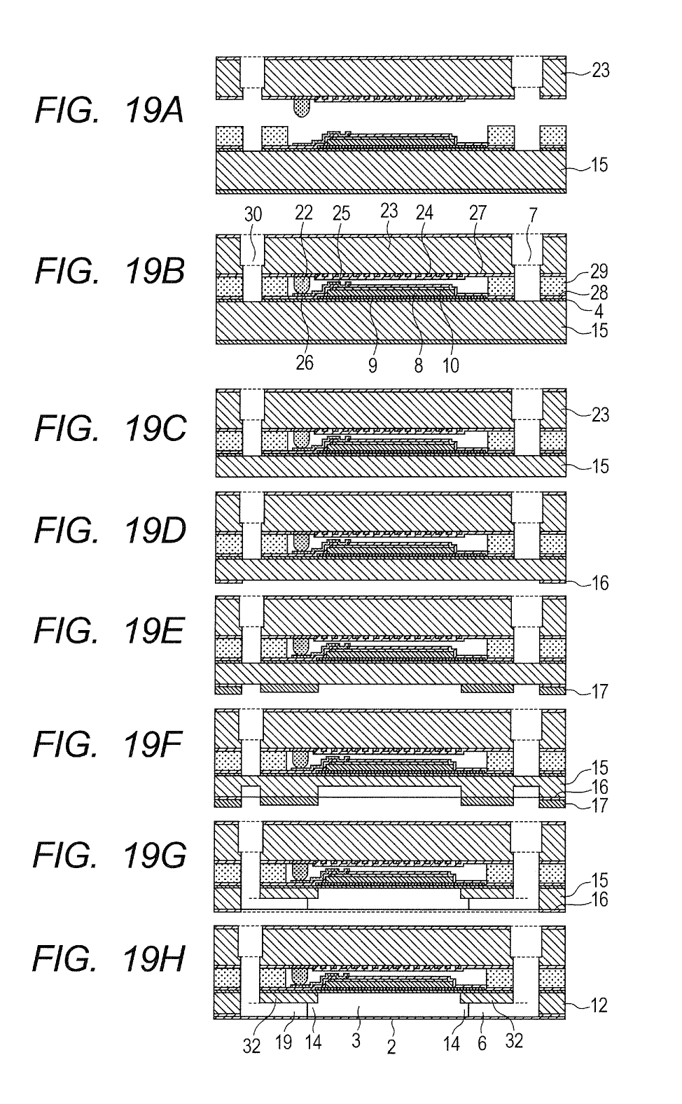

FIGS. 19A to 19H are illustrations of a method of joining together the substrate 15 having the diaphragm 4, the actuating portion 5, the protective film 28, and the structure 29 formed thereon and the wiring substrate 23 having the wiring 24, the protective film 25, the communicating holes 7 and 30, and the bump 22 formed thereon to form the pressure chamber 3. First, the substrate 15 and the wiring substrate 23 that have been subjected to the processing described with reference to FIGS. 17A to 17K and FIGS. 18A to 18J, respectively, are prepared (FIG. 19A). The substrate 15 and the wiring substrate 23 are electrically connected to each other via the bump 22, and at the same time, photosensitive film joining is carried out (FIG. 19B).

Then, the surface of the substrate 15 on the side opposite to the wiring substrate 23 side is ground to a desired thickness (FIG. 19C). After that, the first resist 16 is formed (FIG. 19D), and the second resist 17 is formed (FIG. 19E). At this time, similarly to the case of the first embodiment, the openings are formed in the first resist 16 and the second resist 17 so that the opening edge of the second resist 17 is located on the pressure chamber 3 side with respect to the exposed width change portion of the first resist 16.

Then, the substrate 15 is etched with the first resist 16 and the second resist 17 being used as the mask (FIG. 19F). After that, the second resist 17 is removed, and the substrate 15 is further etched with the remaining first resist 16 being used as the mask (FIG. 19G). A hole that reaches the diaphragm 4 is formed in the substrate 15, and the flow path forming member 12 (see FIGS. 1A to 1D) formed of the substrate 15 is completed.

Finally, the orifice forming member 11 having the orifice 2 formed therein is mounted on the flow path forming member 12 (FIG. 19H). The pressure chamber 3, the flow reducing portions 6 and 20, and the connecting portions 14 and 21 are formed by the flow path forming member 12 and the orifice forming member 11, and the element substrate 1 is completed.

In the third embodiment, the element substrate 1 forms the circulation path of the liquid, and thus, an element substrate that can continue ejection with more stability can be provided. Further, by forming the connecting portion 14 between the pressure chamber 3 and the flow reducing portion 6 on the supply side and forming the connecting portion 21 between the pressure chamber 3 and the flow reducing portion 20 on the recovery side, stress concentration on the end portion of the diaphragm 4 can be prevented to improve the durability of the diaphragm and to allow the element substrate to perform stable ejection with a long life.

Further, part of the flow path forming member 12 (hereinafter referred to as “structure 32”) is formed in each of the flow reducing portion 6 and the flow reducing portion 20 on the diaphragm 4 side, and thus, there is an effect that deformation of the diaphragm 4 due to swelling of the photosensitive resin forming the structure 29 in contact with the liquid is inhibited. The formation of the structure 32 has a further effect that change in cross-sectional areas of the flow reducing portion 6 on the supply side and of the flow reducing portion 20 on the recovery side due to deformation of the diaphragm 4 and breakage of the diaphragm 4 are prevented.

The present invention is described above with reference to the embodiments and the examples, but the present invention is not limited to the above-mentioned embodiments and examples. Various changes that may be understood by those who skilled in the art may be made to the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-175520, filed Aug. 29, 2014, which is hereby incorporated by reference herein in its entirety.

What is claimed is:

1. An element substrate, comprising:
an orifice for ejecting liquid;
a diaphragm for causing the liquid to be ejected through the orifice;
a piezoelectric element for deforming the diaphragm;
a pressure chamber for applying a pressure due to deformation of the diaphragm to the liquid;
a flow reducing portion communicating with the pressure chamber and having a width that is smaller than a width of the pressure chamber; and
a connecting portion for communication between the pressure chamber and the flow reducing portion,
the connecting portion and the pressure chamber communicating with each other without level difference in a width direction,
the connecting portion having a depth that is smaller than a depth of the pressure chamber.

2. An element substrate, comprising:
an orifice for ejecting liquid;
a diaphragm for causing the liquid to be ejected through the orifice;
a piezoelectric element for deforming the diaphragm;
a pressure chamber for applying a pressure due to deformation of the diaphragm to the liquid;
a flow reducing portion communicating with the pressure chamber and having a width that is smaller than a width of the pressure chamber; and
a connecting portion for communication between the pressure chamber and the flow reducing portion,
the connecting portion and the pressure chamber communicating with each other without level difference in a width direction,
wherein, when seen from a direction perpendicular to the diaphragm, a boundary between the connecting portion and the pressure chamber extends in one of a linear shape and an arc shape.

3. An element substrate, comprising:
an orifice forming member having an orifice for ejecting liquid formed therein;
a diaphragm for generating a pressure for ejecting the liquid through the orifice;
a flow path forming member for, together with the orifice forming member and the diaphragm, forming a pressure chamber for applying the pressure from the diaphragm to the liquid;
a flow reducing portion communicating with the pressure chamber and having a flow path wall formed by the orifice forming member and the flow path forming member; and
a connecting portion formed between the pressure chamber and the flow reducing portion, for communication between the pressure chamber and the flow reducing portion,
the pressure chamber having a width that is larger than a width of the flow reducing portion,
the connecting portion being formed by the flow path forming member and communicating with the pressure chamber without level difference in a width direction.

4. The element substrate according to claim 3, further comprising a piezoelectric element for deforming the diaphragm.

5. The element substrate according to claim 1, wherein, when seen from a direction perpendicular to the diaphragm, a boundary between the connecting portion and the pressure chamber extends in one of a linear shape and an arc shape.

6. The element substrate according to claim 1, wherein, when seen from a direction perpendicular to the diaphragm, a portion of the diaphragm adjacent to the connecting portion has a trapezoidal shape.

7. The element substrate according to claim 1, wherein the pressure chamber, the flow reducing portion, the diaphragm, and the piezoelectric element comprise a silicon single crystal substrate.

8. The element substrate according to claim 1,
wherein a plurality of the flow reducing portions are formed for one pressure chamber, and
wherein part of the plurality of the flow reducing portions comprise a flow reducing portion for supplying the liquid and another part of the plurality of the flow reducing portions comprise a flow reducing portion for recovering the liquid, to thereby form a circulation path including the pressure chamber.

9. A liquid ejection head, comprising:
an element substrate, comprising:
an orifice for ejecting liquid;
a diaphragm for causing the liquid to be ejected through the orifice;
a piezoelectric element for deforming the diaphragm;
a pressure chamber for applying a pressure due to deformation of the diaphragm to the liquid;
a flow reducing portion communicating with the pressure chamber and having a width that is smaller than a width of the pressure chamber; and
a connecting portion for communication between the pressure chamber and the flow reducing portion,
the connecting portion and the pressure chamber communicating with each other without level difference in a width direction,
the connecting portion having a depth that is smaller than a depth of the pressure chamber; and
a wiring substrate electrically connected to the element substrate.
